(19) United States
(12) Patent Application Publication
(10) Pub. No.: US 2012/0034960 A1
(43) Pub. Date: Feb. 9, 2012

(54) Exercise-book sheet for dysgraphic individuals

(76) Inventor: Rosalba Mercanti, Perugia (PG) (IT)

(21) Appl. No.: 13/136,306

(22) Filed: Jul. 28, 2011

(30) Foreign Application Priority Data
Aug. 3, 2010 (IT) AN2010U000058

(51) Int. Cl. B41L 1/20

(52) U.S. Cl. 462/66

(57) ABSTRACT

The present invention relates to an exercise-book sheet provided with a layout that ensures higher writing ability and accuracy for individuals affected by specific learning disorders, such as dysgraphia.

The present application relates to an exercise-book sheet for individuals affected by a specific learning disorder, known as dysgraphia.

This term is used to indicate the difficulties shown by children in composing words and numbers graphically according to correct sequences and, in particular, respecting a correct spacing layout.

During the composition of words (considered as ordered sequences of alphabet letters), they sometimes omit to separate a word from the next one, whereas in other situations they arbitrarily break a sequence of letters that should stay “tied” in order to originate a complete word.

Likewise, during the written execution of arithmetical operations, with the use of a traditional squared sheet, the aforesaid children show severe difficulties in respecting the typical positional values of digits in numbers formed of multiple digits (i.e. within a traditional division in thousands, hundreds, tenths and units) and positioning each digit in a single square.

This involves the additional difficulty in tabulating numbers made of multiple digits correctly within the typical layout provided for the correct execution of additions, subtractions or multiplications.

It is worthless saying that the above difficulties make it extremely difficult, if not impossible to learn multiplication tables, memorize sequences of measurement units necessary to make equivalences and carry out similar, although not very complex activities.

A careful reflection on these problems, together with the awareness of the inefficacy of the instruments that have been used so far in order to overcome them, has led to devise the innovative exercise-book sheet that is the object of this patent application.

In particular, the present invention is based on the intuition that, in front of a traditional squared sheet, dysgraphic individuals do not find a real reference point on said sheet.

It was understood that the traditional network formed of thin vertical and horizontal lines, which is printed on an ordinary squared sheet, is not a sufficient aid for dysgraphic individuals that are required to operate a correct division of the various sequences of letters and numbers.

Starting from this assumption, the inventive idea has been to continue on using the division in lines and columns of a squared sheet, while providing for an important innovation.

Whereas in a traditional squared sheet the horizontal and vertical lines cross to form a network, in the new exercise-book sheet of the invention the aforesaid network is formed by using the horizontal lines only, in combination with a series of regularly alternating vertical bands with two different colors.

The use of two different colors ensures a more immediate recognition of such a “network” partition of the sheet of the invention, even at the eyes of individuals affected by the aforesaid disorders.

It can be otherwise said that in such a way a plurality of boxes is obtained on the sheet, which are clearly perceived by potential users because of the alternating use of two different colors.

In such a situation users will be required to use the boxes by writing one digit or one letter in each of them.

While doing this, moreover, users will find a significant aid in each of said horizontal lines available on the sheet of the invention, in order to align the various digits or letters correctly, one after the other.

For purposes of clarity, the description of the invention continues with reference to the enclosed drawing, which is intended for purposes of illustration only and not in a limiting sense, wherein:

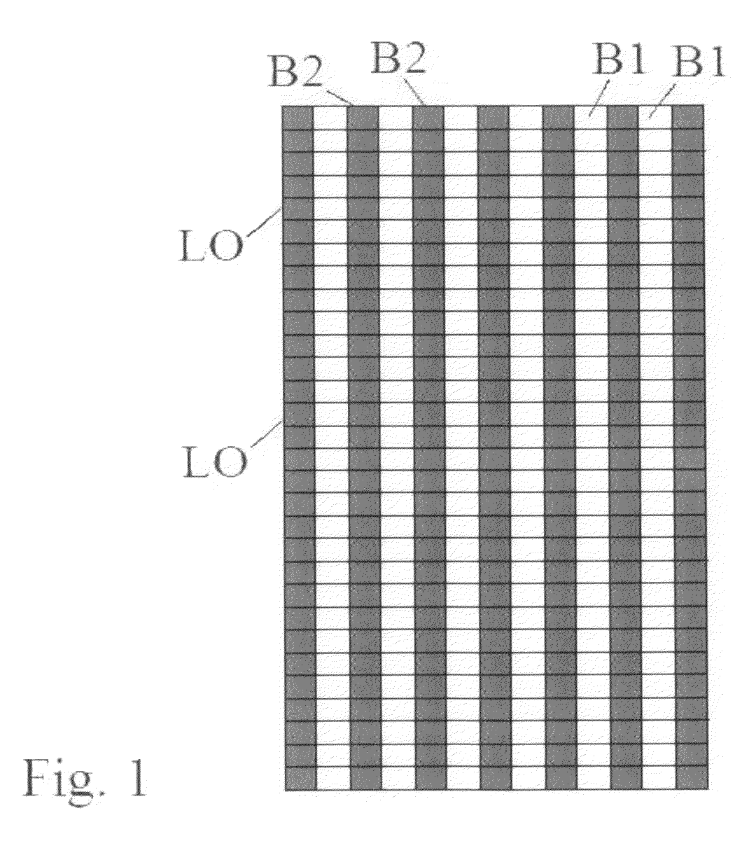

FIG. 1 is a view of the exercise-book sheet of the invention;

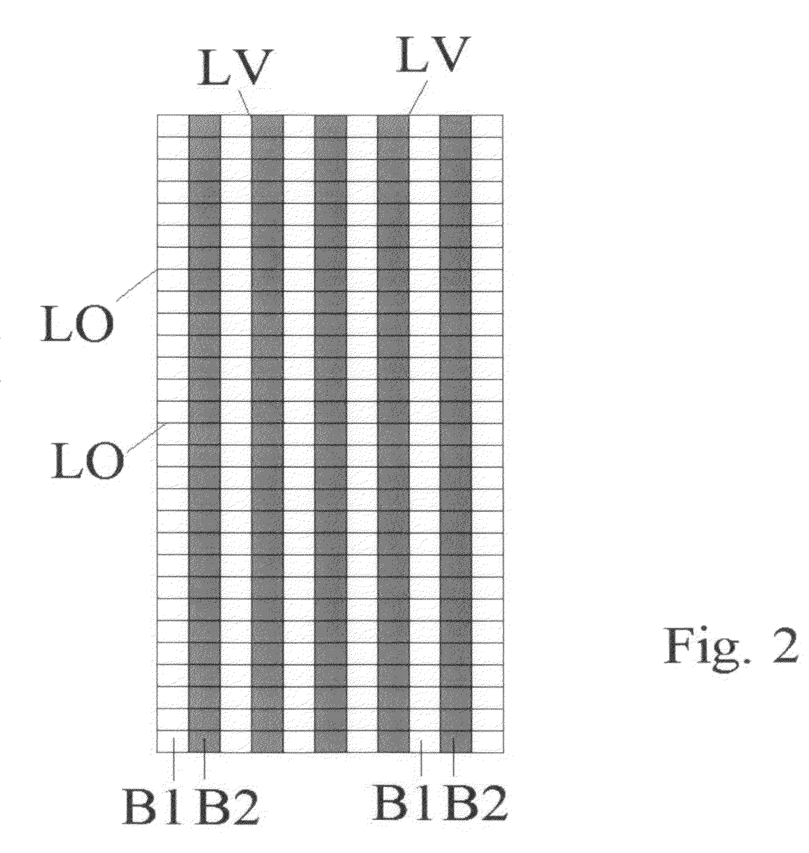

FIG. 2 is a view of a second embodiment of said sheet;

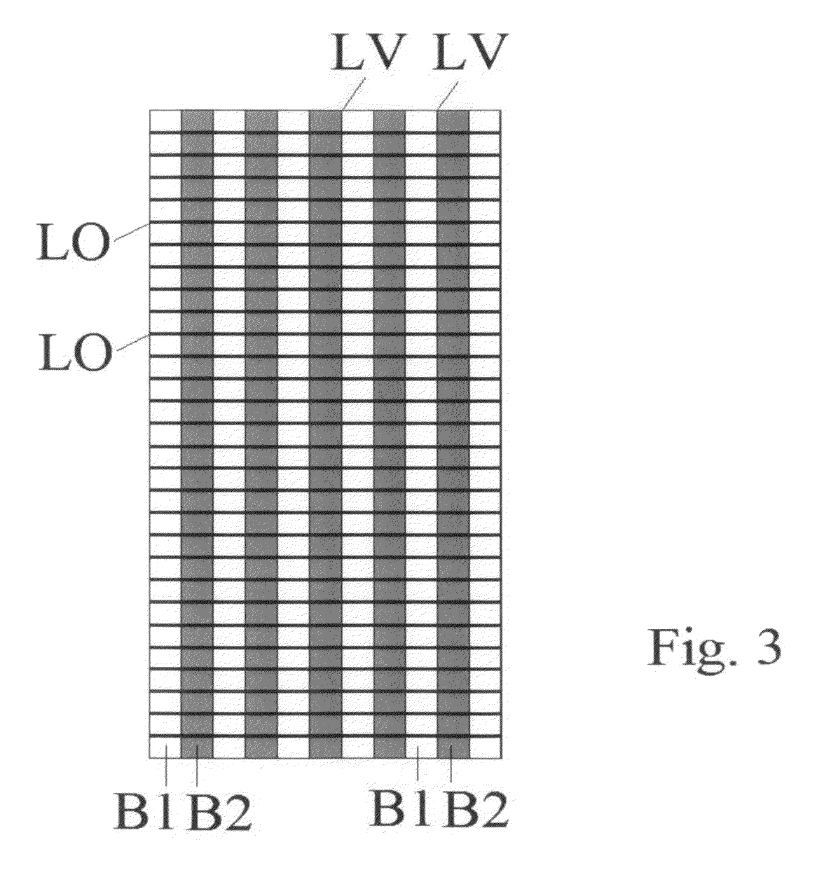

FIG. 3 is a view of a third embodiment of said sheet.

Referring to FIG. 1, the exercise-book sheet of the invention (1) is provided with a plurality of regularly spaced horizontal lines (LO), as well as with a plurality of vertical bands (B1, B2) with same width, obtained with two regularly alternating colors.

As shown in the same figure, such a crossing of horizontal lines (LO) and vertical bands (B1, B2) generates a bichromatic network wherein a plurality of boxes is identified.

Considering that users of such a sheet are normally required to write horizontally, it may be otherwise stated that, line by line, users are in presence of a regular alternation of boxes with two different colors.

Because of this, users are immediately able to perceive each of said boxes as the spacing assigned to a digit or letter of a specific sequence or as the spacing designed to remain empty in order to separate a number or word from the following one.

So, dysgraphic individuals are able, without any error margin, to write words and numbers correctly, as well as to recognize the correct positional value of each digit in numbers with more than two digits and also tabulate numbers correctly.

As shown in the enclosed figures, the first series of vertical bands (B1) uses the background color of the sheet of the invention (1) and the second series of said bands (B2), which is alternated with the first series (B1), is obtained with a different light color (light grey, light blue, aqua green, etc.) that makes printed digits or letters visible.

It is understood that within the same inventive idea, an alternative color (which is different from the background color of the sheet) can be used to make the vertical bands (B1) of the first series, being provided that said color is sufficiently light and different from the one used to make the adjacent vertical bands (B2) of the second series.

Regardless of what shown in FIG. 1, according to the present invention the spacing between the horizontal lines (LO) of the sheet (1) does not necessarily coincide with the width of said vertical bands (B1, B2).

Likewise, the horizontal lines (LO) can have a non-constant spacing and/or a different thickness.

In spite of being convinced of the great efficacy of the sheet (1) shown in FIG. 1, a second embodiment of said sheet (1) has been devised, which is adapted to create an even higher visual impact at the eyes of dysgraphic individuals and further favor the identification of spaces used to write numbers and words.

According to the second embodiment of the invention shown in FIG. 2, said horizontal lines (LO) are intersected by vertical lines (LV) disposed with a spacing that corresponds to the width of said bands (B1, B2); it being provided, in such a case, that also the horizontal lines (LO) have the same spacing as the vertical lines (LV).

Such a crossing of lines (LO, LV) allows for a clearer identification of the boxes of said bichromatic network, thus favoring the task of individuals required to use the boxes to write an ordered sequence of digits or letters.

According to the second embodiment, the horizontal lines (LO) can have a thickness higher than the vertical lines (LV), as shown in FIG. 3.

As a matter of fact, the higher thickness of the horizontal lines (LO) catches the user's attention and helps him to put the various digits of a number or the various letters of a word correctly in line.

Finally, it must be noted that the horizontal lines (LO) can be alternatively made with a continuous or broken line for all alternative embodiments of the sheet of the invention (1).

1) An exercise-book sheet wherein it is provided with a plurality of horizontal lines (LO) crossing with a plurality of vertical bands (B1, B2) with identical width, obtained with two regularly alternating colors.

2) An exercise-book sheet as claimed in claim 1, wherein said horizontal lines (LO) are regularly spaced.

3) An exercise-book sheet as claimed in claim 2, wherein the spacing provided between said horizontal lines (LO) corresponds to the width of said vertical bands (B1, B2).

4) An exercise-book sheet as claimed in claim 2, wherein the spacing provided between said horizontal lines (LO) does not correspond to the width of said vertical bands (B1, B2).

5) An exercise-book sheet as claimed in claim 1, wherein said horizontal lines (LO) are intersected by vertical lines (LV) disposed with a spacing that corresponds to the width of said bands (B1, B2); it being provided, that also said horizontal lines (LO) have the same spacing as the vertical lines (LV).

6) An exercise-book sheet as claimed in claim 5, wherein said horizontal lines (LO) have a higher thickness than vertical lines (LV).

7) An exercise-book sheet as claimed in claim 1, wherein said horizontal lines (LO) are obtained with a continuous or broken line.

8) An exercise-book sheet as claimed in claim 1, wherein all said horizontal lines (LO) have the same thickness.

9) An exercise-book sheet as claimed in claim 1, wherein said horizontal lines (LO) have different thickness.

10) An exercise-book sheet as claimed in claim 1, wherein the two colors used to create alternation of said vertical bands (B1, B2) are white and a different light color, in such a way to make printed digits or letters visible.

11) An exercise-book sheet as claimed in claim 1, wherein the two colors used to create alternation of said vertical bands (B1, B2) are two light colors other than white.
